(19) United States
(12) Patent Application Publication
(10) Pub. No.: US 2011/0232450 A1
(43) Pub. Date: Sep. 29, 2011

(54) EQUIPMENT FOR CUTTING CORRUGATED FIN

(76) Inventors: Masaki UEHARA, Tokyo (JP); Mitsuhiro MOTOKI, Tokyo (JP); Toshiyuki NANAARASHI, Tokyo (JP)

(21) Appl. No.: 13/026,903

(22) Filed: Feb. 14, 2011

(30) Foreign Application Priority Data
Mar. 25, 2010 (JP) 2010-069662

(51) Int. Cl. B23D 23/00

(52) U.S. Cl. 83/568

(57) ABSTRACT

The equipment for cutting a corrugated fin is capable of sufficiently cutting a corrugated fin having high ribs. The equipment comprises: a movable blade moving into a rib of a corrugated fin and cutting the corrugated fin; and a fixed blade being fixed on the opposite side of the corrugated fin from the movable blade, the fixed blade cutting the rib with the movable blade. A tip section, which has a cutting face capable of cutting the rib with the fixed blade, is provided to a front end of the movable blade. A supporting block supports one of outer faces of the rib, which corresponds to the tip section of the movable blade, and is biased upward, thereby the supporting block is moved downward together with the cut rib, which has been cut and pushed downward by the movable blade, with continuously supporting the outer face of the cut rib.

### CROSS-REFERENCE TO RELATED APPLICATION

This application is based upon and claims the benefit of priority of the prior Japanese Patent Application No. 2010-069662, filed on Mar. 25, 2010, and the entire contents of which are incorporated herein by reference.

### FIELD

The present invention relates to an equipment for cutting a corrugated fin, in which a plurality of ribs are formed in a metal plate at regular intervals, at a prescribed position.

### BACKGROUND

An example of corrugated fins is shown in FIG. 7. The shown corrugated fin 10 is a flat corrugated fin, in which ribs 12 are vertically formed in a metal plate 9.

In the corrugated fin 10, the metal plate 9 is composed of, for example, aluminum, and the ribs 12 are continuously formed. The corrugated fin 10 is used in a radiator of a vehicle, a heat exchanger of an air conditioner, EGR (Exhaust Gas Recirculation), etc.

For example, conventional equipments for cutting a corrugate fin are disclosed in Japanese Laid-open Patent Publications No. 2007-54928 and No. 2008-62314.

One of the conventional equipments is shown in FIG. 8. A movable blade 14 is provided above a corrugated fin 10 to be cut. The movable blade 14 can be moved upward and downward. A fixed blade 15 is provided under the corrugated fin 10. The movable blade 14 is moved toward the fixed blade 15 so as to cut the corrugated fin 10. A front end (lower end) of the movable blade 14 is constituted by a cutting face 14a, which cuts the rib 12 with the fixed blade 15, and a slope face 14b, which makes the lower end sharp.

The movable blade 14 is capable of moving into the rib 12 of the corrugated fin 10, and the sharpened lower end cuts a bottom part of the rib 12.

In the conventional equipment shown in FIG. 8, a width of the movable blade 14, in a direction of conveying the corrugated fin 10, is wider than that of the ribs 12. So the movable blade 14 broadens the width of the rib 12 to be cut. Therefore, the conventional equipment cannot produce a corrugated fin in which all of ribs have the same width.

To produce a corrugated fin in which all of ribs have the same width, the width of the movable blade 14 must be smaller than that of the ribs.

These days, a height of ribs (a depth of grooves between ribs) of a corrugated fin has been increased so as to enhance heat exchange efficiency.

In case of cutting the corrugated fin having the high ribs, vertical lengths of the movable blade 14 and the fixed blade 15 must be long. Further, if the width of the movable blade 14 is small, toughness of the movable blade 14 will be insufficient, so the corrugated fin cannot be cut sufficiently and the movable blade 14 will be easily broken.

### SUMMARY

Accordingly, it is an object in one aspect of the invention to provide an equipment for cutting a corrugated fin, which is capable of sufficiently cutting a corrugated fin having high ribs.

To achieve the object, the equipment for cutting a corrugated fin, comprises:
a movable blade moving into a rib of a corrugated fin and cutting the corrugated fin; and
a fixed blade being fixed on the opposite side of the corrugated fin from the movable blade, the fixed blade cutting the rib with the movable blade,

a tip section, which has a cutting face capable of cutting the rib with the fixed blade, is provided to a front end of the movable blade, and

a supporting block supports one of outer faces of the rib, which corresponds to the tip section of the movable blade, and is biased upward, thereby the supporting block is moved downward together with the cut rib, which has been cut and pushed downward by the movable blade, with continuously supporting the outer face of the cut rib.

With this structure, the outer face of the cut rib, which has been cut and moved downward by the tip section, is continuously supported by the supporting block, so the supporting block helps the cutting action of the tip section. Therefore, even if the movable blade does not have great toughness, the corrugated fin can be securely cut.

Preferably, a part of the movable blade other than the tip section contacts and slides on an inner face of the rib.

With this structure, the rib is not broadened when the movable blade moves into the rib.

Preferably, the cutting face of the tip section of the movable blade is shifted from a transversal center of the rib.

With this structure, in case that the rib need not be cut at the transversal center thereof, the tip section can be made broader. Therefore, toughness of the tip section can be increased.

Preferably, a flat face is formed at a front end of the tip section of the movable blade.

With this structure, the front end of the tip section need not be made an acute angle. Therefore, the tip section can obtain sufficient toughness.

Preferably, the equipment further comprises a lifter capable of contacting a lower face of the corrugated fin, which has been cut, so as to lift the cut rib from the supporting block.

With this structure, the rib held by the supporting block can be securely separated from the supporting block.

Preferably, an end face of the lifter, which is located on the supporting block side, slides on the supporting block.

With this structure, the end face of the lifter, which is located on the supporting block side (the downstream side in the conveying direction of the corrugated fin), contacts an end face of the lifter, which is located on the upstream side, so that the vertical movement of the supporting block can be guided smoothly.

By employing the equipment of the present invention, even the corrugated fin having the high rib can be sufficiently cut without broadening the rib.

### BRIEF DESCRIPTION OF THE DRAWINGS

Embodiments of the present invention will now be described by way of examples and with reference to the accompanying drawings, in which:

FIG. 1 is a side view of the equipment for cutting a corrugated fin relating to the present invention;

FIG. 2 is an enlarged view of a tip section of a movable blade of the equipment shown in FIG. 1;

FIG. 3 is an enlarged view of a tip section, whose shape is different from the tip section shown in FIG. 2;

FIG. 4 is an enlarged view of a tip section, whose shape is different from the tip sections shown in FIGS. 2 and 3;

FIG. 5 is a side view of the equipment shown in FIG. 1, in which a movable block is moved downward;

FIG. 6 is a side view of the equipment shown in FIG. 1, in which the movable block is further moved downward from the position shown in FIG. 5 to a lower dead point;

FIG. 7 is a side explanation view of the corrugated fin; and

FIG. 8 shows explanation views of the conventional cutting equipment.

### DETAILED DESCRIPTION OF THE EMBODIMENTS

Preferred embodiments of the present invention will now be described in detail with reference to the accompanying drawings.

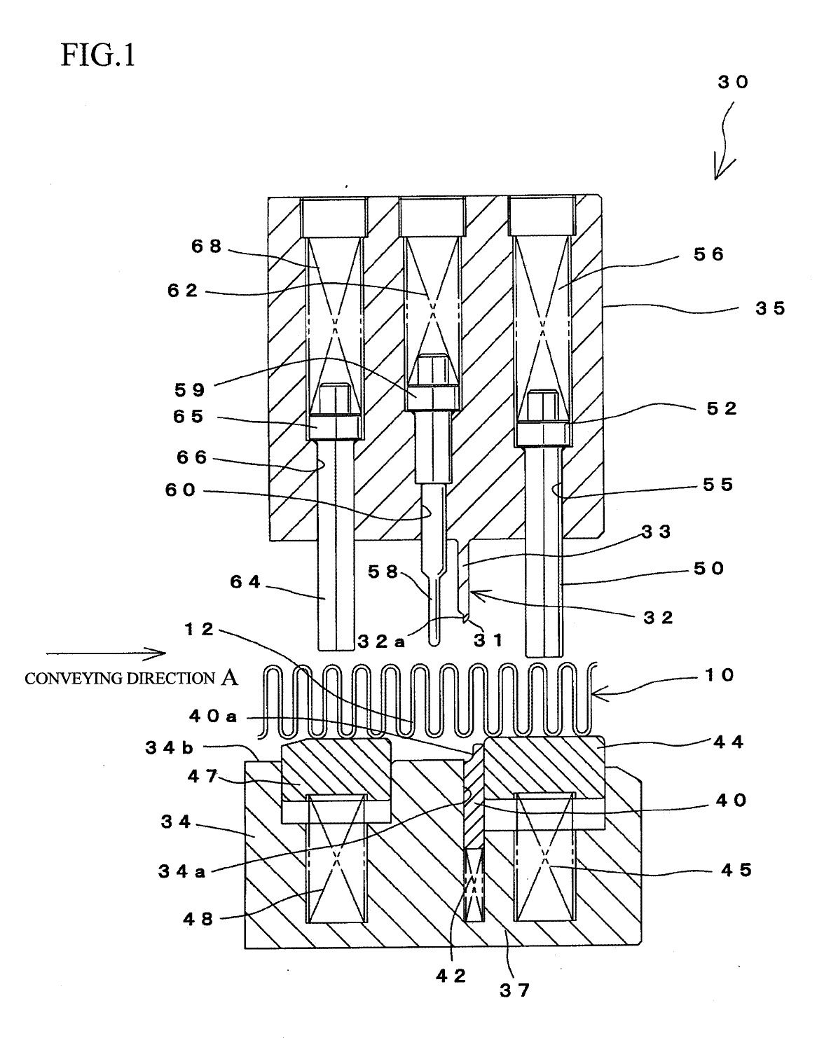

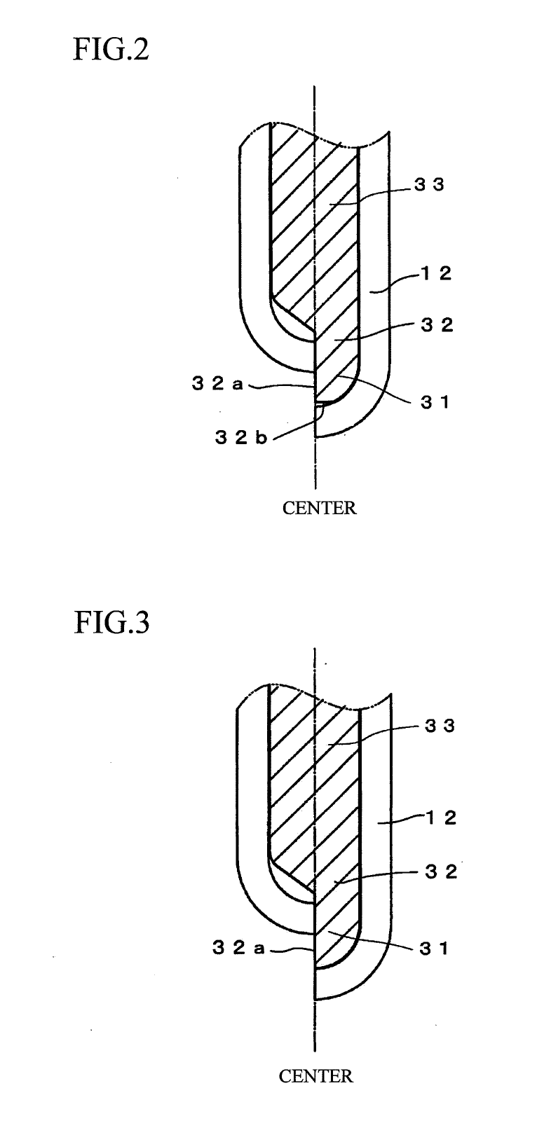

FIG. 1 is a side view of the equipment relating to the present invention. FIGS. 2-4 are enlarged views of examples of a tip section of a movable blade.

The corrugated fin cutting equipment 30 of the present invention cuts a corrugated fin 10, which has been continuously produced by a corrugated fin production equipment (not shown) and conveyed therefrom, to a prescribed length.

The corrugated fin 10 is conveyed in a conveying direction A (from the left side to the right side in FIG. 1).

The cutting equipment 30 includes: a movable blade 32 being provided above the corrugated fin 10 and moved upward and downward; and a fixed blade 34 being provided on the opposite side of the corrugated fin 10 from the movable blade 32.

The movable blade 32 is provided to a movable block 35, which is moved upward and downward by a driving unit (not shown), e.g., hydraulic cylinder unit. In the present embodiment, the movable blade 32 is integrated with the movable block 35, but they need not be integrated as far as they can be moved integrally.

On the other hand, the fixed blade 34 is provided on the opposite side of the corrugated fin 10 from the movable blade 32. For example, the fixed blade 34 is integrated with a fixed block 37, which is fixed under the corrugated fin 10. The fixed blade 34 cuts the corrugated fin 10 with the movable blade 32 moved downward. The fixed blade 34 has a cutting face 34a, which is formed in the vertical direction and capable of sliding on a cutting face 32a of the movable blade 32. An upper face of the fixed blade 34 is a flat face 34b acting as a mounting face. The cutting face 34a is formed at an end of the mounting face 34b on the downstream side in the conveying direction A. The mounting face 34b is perpendicular to the cutting face 34a. An edge constituted by the faces 34a and 34b acts as the blade edge for cutting the corrugated fin 10.

A supporting block 40 is provided to the fixed block 37. The supporting block 40 supports an outer face of the rib 12 to be cut, which is located on the downstream side in the conveying direction A (which corresponds to a tip section 31 of the movable blade 32). The movable blade 32 moves into the rib 12 to be cut. A side face of the supporting block 40 on the upstream side in the conveying direction A is made flat in the vertical direction so as to contact and slide on the cutting face 34a of the fixed blade 34.

The supporting block 40 has a supporting section 40a, whose shape corresponds to that of the outer face of the rib 12 of the corrugated fin 10, so as to support the rib 12 to be cut. The cutting equipment 30 cuts the corrugated fin 10 along a center line of the rib 12 to be cut. The cutting position is slightly varied according to the shape of the tip section 31. The supporting section 40a has a prescribed shape which is capable of supporting a half of the cut rib 12 on the downstream side in the conveying direction A.

A biasing member 42, e.g., coil spring, is provided between a lower face of the supporting block 40 and the fixed block 37 so as to always bias the supporting block 40 upward.

As shown in FIG. 1, the supporting block 40 is biased upward, by the biasing member 42, and an inner bottom face of the supporting section 40a, which supports a bottom face of the rib 12 to be cut, corresponds to or nearly corresponds to the mounting face 34a of the fixed blade 34 before starting the cutting action of the equipment 30.

When the movable blade 32 is moved downward and into the rib 12 to be cut, the movable blade 32 cuts the rib 12 and pushes the rib 12, which has been cut, downward. The outer face of the cut rib 12 on the downstream side is supported by the supporting section 40a of the supporting block 40. The movable blade 32 moves the supporting block 40 downward against the elasticity of the biasing member 42.

Lifters 44 and 47 are provided on the downstream and the upstream sides, in the conveying direction A, of the supporting block 40. The lifter 44 located on the downstream side of the supporting block 40 separates the corrugated fin 10, which has been cut to the prescribed length, from the supporting section 40a of the supporting block 40. An upper face of the lifter 44 is a flat face.

The lifter 44 contacts the lower face of the corrugated fin 10, which is still not cut, and supports the corrugated fin 10 before starting the cutting action of the equipment 30 (see FIG. 1).

A biasing member 45, e.g., coil spring, is provided between a lower face of the lifter 44 and the fixed block 37 so as to always bias the lifter 44 upward. A killer pin 50 is capable of contacting the upper face of the lifter 44 so as to move the lifter 44 downward.

Before starting the cutting action of the equipment 30, an upper face of the lifter 47 located on the upstream side corresponds to the upper face of the lifter 44 located on the downstream side, and the lifter 47 contacts the lower face of the corrugated fin 10, which is still not cut, and supports the corrugated fin 10 with the lifter 44 (see FIG. 1).

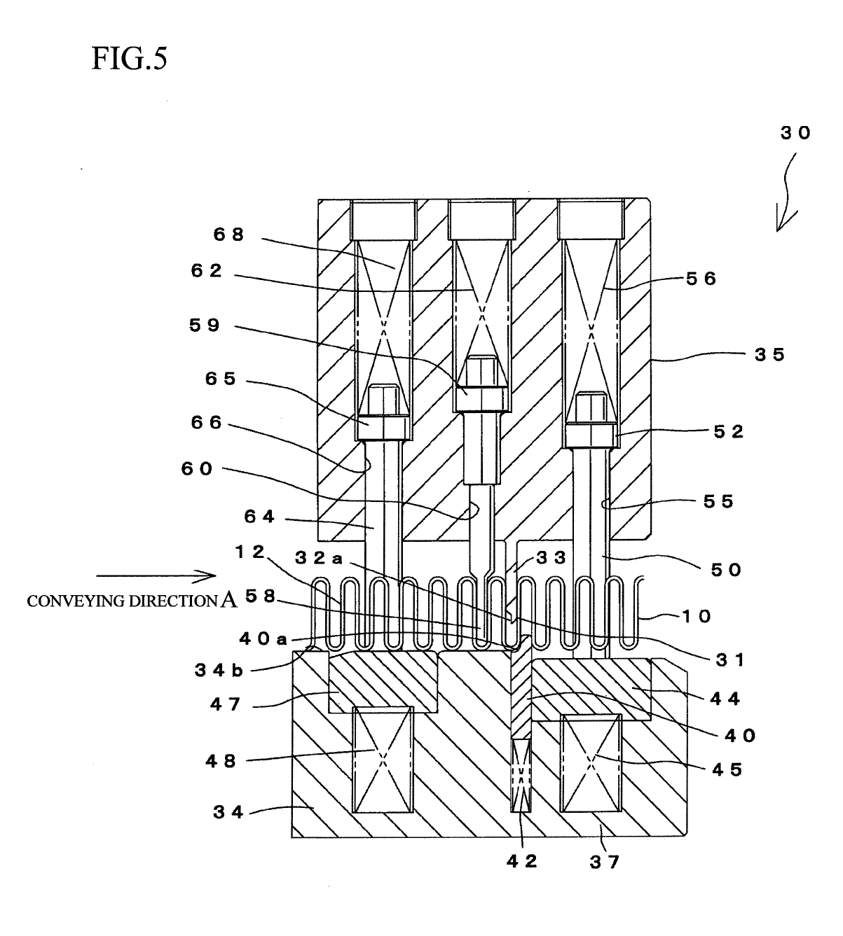

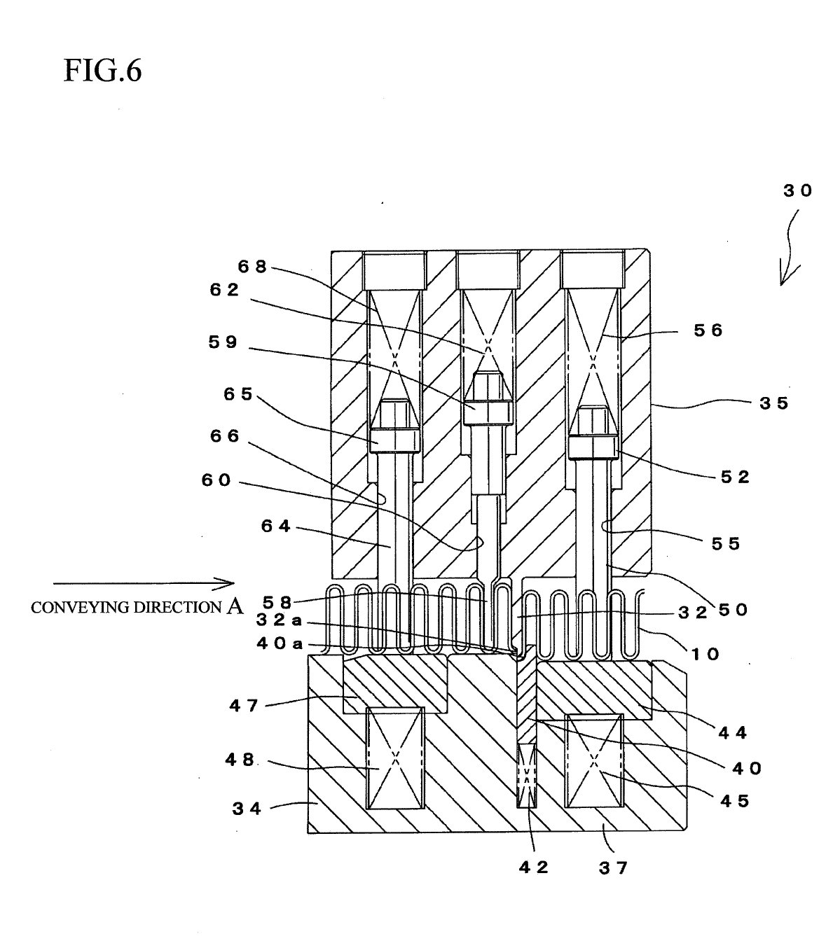

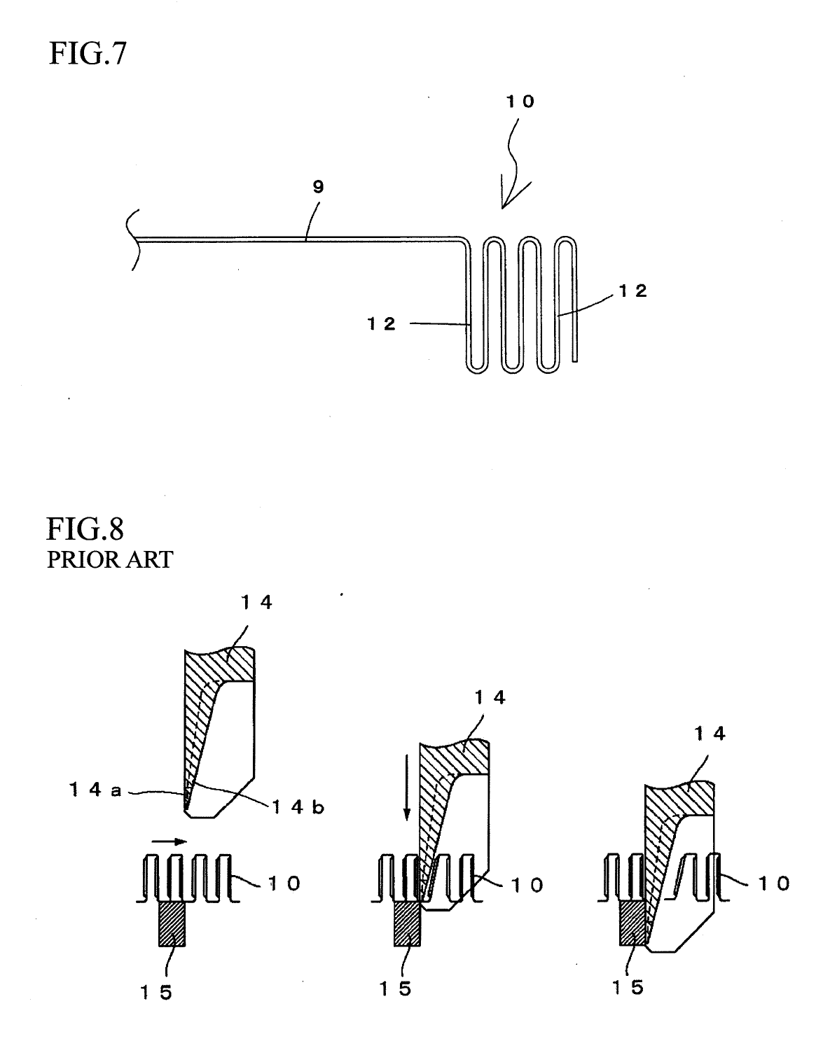

A biasing member 48, e.g., coil spring, is provided between a lower face of the lifter 47 and the fixed block 37 so as to always bias the lifter 47 upward. A killer pin 64 is capable of contacting the upper face of the lifter 47 so as to move the lifter 47 downward. Note that, a lower position of the lifter 47, which is moved downward by the killer pin 64, is higher than that of the lifter 44. When the lifter 47 reaches the lower position, the upper face of the lifter 47 corresponds to the mounting face 34a of the fixed blade 34 (see FIGS. 5 and 6).

An end face of the lifter 44, which is located on the upstream side in the conveying direction A, contacts and slides on a side face of the supporting block 40, which is located on the downstream side in the conveying direction A. With this structure, the side face of the supporting block, which is located on the upstream side, is guided by the fixed blade 34b, and the other side face thereof, which is located on the downstream side, is guided by the lifter 44, so that the supporting block 44 can be smoothly moved upward and downward.

A killer pin 50 is downwardly projected from the movable block 35. A lower end face of the killer pin 50 contacts the upper face of the lifter 44 so as to restrict the movement of the lifter 44.

A flange 52, whose diameter is larger than that of the killer pin 50, is provided to an upper part of the killer pin 50. The killer pin 50 is pierced through a through-hole 55, and the flange 52 can engage with an upper edge of the through-hole 55 so as to prevent the killer pin 50 from falling off from the through-hole 55.

A biasing member 56, e.g., coil spring, is provided between the upper part of the killer pin 50 and the movable block 35 so as to always bias the killer pin 50 downward.

As described above, the lifter 44 separates the corrugated fin 10, which has been cut, from the supporting section 40a of the supporting block 40, so the lifter 44 and the killer pin 50 for the killer pin 50 for restricting the movement of the lifter 44 are located on the downstream side, in the conveying direction A, of the movable blade 32.

In the movable block 35, a pilot pin 58, which correctly positions the corrugated fin 10 while performing the cutting action, is located on the upstream side, in the conveying direction A, of the movable blade 32. While performing the cutting action, the pilot pin 58 is moved into the prescribed rib 12, which is located on the upstream side of the cutting position of the corrugated fin 10, from the upper side, so as to correctly position the corrugated fin 10.

A sectional view of shape of the pilot pin 58 nearly corresponds to that of the rib 12, so the pilot pin 58 can move into the rib 12.

A flange 59, whose diameter is larger than that of the pilot pin 58, is provided to an upper part of the pilot pin 58. The pilot pin 50 is pierced through a through-hole 60, and the flange 59 can engage with an upper edge of the through-hole 60 so as to prevent the pilot pin 58 from falling off from the through-hole 60.

A biasing member 62, e.g., coil spring, is provided between the upper part of the pilot pin 58 and the movable block 35 so as to always bias the pilot pin 58 downward.

In the movable block 35, a killer pin 64 is located on the upstream side, in the conveying direction A, of the pilot pin 58. A killer pin 64 is downwardly projected from the movable block 35. A lower end face of the killer pin 64 contacts the upper face of the lifter 47 so as to restrict the movement of the lifter 47.

A flange 65, whose diameter is larger than that of the killer pin 64, is provided to an upper part of the killer pin 64. The killer pin 64 is pierced through a through-hole 66, and the flange 65 can engage with an upper edge of the through-hole 66 so as to prevent the killer pin 64 from falling off from the through-hole 66.

A biasing member 68, e.g., coil spring, is provided between the upper part of the killer pin 64 and the movable block 35 so as to always bias the killer pin 64 downward.

Successively, examples of the movable blade 32 will be explained with reference to FIGS. 2-4. In each of FIGS. 2-4, the movable blade 12 moves into the rib 12 and cuts the ribs 12.

FIG. 2 is an enlarged view of the movable blade 32 shown in FIG. 1. The movable blade 32 includes the tip section 31, which has the cutting face 32a. The cutting face 32a corresponds to the center of the rib 12 in the conveying direction A. The tip section 31 is located on the downstream side of the center of the rib 12. A width of a main body part 33 of the movable blade 32 is slightly smaller than a distance between inner wall faces of the rib 12. Therefore, the main body part 33 can slide on the inner wall faces of the rib 12. The main body part 33 can be moved into the rib 12, but it does not broaden the rib 12. The main body part 33 can be moved upward and downward in the rib 12.

The tip section 31 is not sharpened. A lower end of the tip section 31 is formed into a flat face 32b so as to prevent the lower end from being formed too narrow and secure enough toughness.

Note that, the flat face 32b need not be a horizontal face.

In the example shown in FIG. 3, the tip section 31 of the movable blade 32 has the cutting face 32a, which corresponds to the center of the rib 12 in the conveying direction A. No flat face is formed at lower end of the tip section 31. Namely, the lower end of the tip section 31 is sharpened.

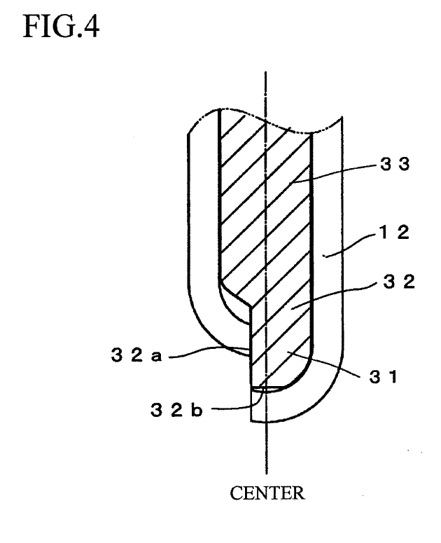

In the example shown in FIG. 4, the tip section 31 of the movable blade 32 has the cutting face 32a, which is shifted from the center (transversal center) of the rib 12 in the conveying direction A. The cutting face 32a is located on the upstream side of the center of the rib 12. With this structure, a width of the tip section can be increased, so that the tip section 31 can have enough toughness.

Next, the cutting action of the equipment 30 will be explained with reference to FIGS. 5 and 6.

In the state shown in FIG. 1, the movable block 35 is located at an upper position. In this state, the corrugated fin 10 is conveyed, by a conveyor unit (not shown), in the conveying direction A.

Next, as shown in FIG. 5, the movable block 35 is moved downward. The pilot pin 58 is moved downward and into the prescribed rib 12. By moving into the prescribed rib 12, the pilot pin 58 can correctly position the corrugated fin 10.

The lower end of the killer pin 50 presses the upper face of the lifter 44 to move the lifter 44 downward. At that time, the lifter 44 is moved downward until the upper face reaches a position lower than the mounting face 34b of the fixed blade 34. Therefore, the corrugated fin 10, which has been mounted on the lifter 44, is mounted on the mounting face 34b of the fixed blade 34.

In a state shown in FIG. 5, the movable blade 32 is moving into the rib 12 to be cut. The outer face of the rib 12 on the downstream side in the conveying direction A contacts the supporting section 40a of the supporting block 40.

The lower end of the killer pin 64 presses the upper face of the lifter 47 to move the lifter 47 downward. At that time, the lifter 47 is moved downward until the upper face reaches a position corresponding to the mounting face 34b of the fixed blade 34. Therefore, the corrugated fin 10 is mounted on the mounting face 34b of the fixed blade 34 and the upper face of the lifter 47.

In a state shown in FIG. 6, the movable blade 32 is moved into the rib 12 to be cut and cuts the same, so that the corrugated fin 10 can be completely cut.

While performing the cutting action, the movable blade 32 cuts the rib 12 and pushes the cut rib 12 downward. In the state where the movable blade 32 pushes the rib 12 downward, the outer face of the cut rib 12 located on the downstream side in the conveying direction A has been continuously supported by the supporting section 40a of the supporting block 40. The supporting block 40 is moved downward, by the movable blade 32 and the cut rib 12 being moved downward, against the elasticity of the biasing member 42. The outer face of the rib 12 is supported by the supporting block which can be moved downward together with the movable blade 22. Therefore, even in case of cutting the corrugated fin 10 having the high ribs 12, defectively cutting the corrugated fin 10 and breaking the movable blade 32, which are caused by poor toughness of the movable blade 32, can be prevented.

After completing the cutting action, the movable block 35 is moved upward and the lower end of the killer pin 50 is separated from the upper face of the lifter 44, so that the lifter 44 is moved upward by the elasticity of the biasing member 45. Therefore, the cut corrugated fin 10 is moved upward and securely separated from the supporting block 40.

The cut corrugated fin 10 is further conveyed in the conveying direction A.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention has been described in detail, it should be understood that the various changes, substitutions, and alternations could be made hereto without departing from the spirit and scope of the invention.

1. An equipment for cutting a corrugated fin, comprising:
a movable blade moving into a rib of a corrugated fin and cutting the corrugated fin; and
a fixed blade being fixed on the opposite side of the corrugated fin from the movable blade, the fixed blade cutting the rib with the movable blade,
wherein a tip section, which has a cutting face capable of cutting the rib with the fixed blade, is provided to a front end of the movable blade,
a supporting block supports one of outer faces of the rib, which corresponds to the tip section of the movable blade, and is biased upward, thereby the supporting block is moved downward together with the cut rib, which has been cut and pushed downward by the movable blade, with continuously supporting the outer face of the cut rib.

2. The equipment according to claim 1,
wherein a part of the movable blade other than the tip section contacts and slides on an inner face of the rib.

3. The equipment according to claim 1,
wherein the cutting face of the tip section of the movable blade is shifted from a transversal center of the rib.

4. The equipment according to claim 2,
wherein the cutting face of the tip section of the movable blade is shifted from a transversal center of the rib.

5. The equipment according to claim 1,
wherein a flat face is formed at a front end of the tip section of the movable blade.

6. The equipment according to claim 2,
wherein a flat face is formed at a front end of the tip section of the movable blade.

7. The equipment according to claim 3,
wherein a flat face is formed at a front end of the tip section of the movable blade.

8. The equipment according to claim 4,
wherein a flat face is formed at a front end of the tip section of the movable blade.

9. The equipment according to claim 1,
further comprising a lifter capable of contacting a lower face of the corrugated fin, which has been cut, so as to lift the cut rib from the supporting block.

10. The equipment according to claim 2,
further comprising a lifter capable of contacting a lower face of the corrugated fin, which has been cut, so as to lift the cut rib from the supporting block.

11. The equipment according to claim 3,
further comprising a lifter capable of contacting a lower face of the corrugated fin, which has been cut, so as to lift the cut rib from the supporting block.

12. The equipment according to claim 4,
further comprising a lifter capable of contacting a lower face of the corrugated fin, which has been cut, so as to lift the cut rib from the supporting block.

13. The equipment according to claim 5,
further comprising a lifter capable of contacting a lower face of the corrugated fin, which has been cut, so as to lift the cut rib from the supporting block.

14. The equipment according to claim 6,
further comprising a lifter capable of contacting a lower face of the corrugated fin, which has been cut, so as to lift the cut rib from the supporting block.

15. The equipment according to claim 7,
further comprising a lifter capable of contacting a lower face of the corrugated fin, which has been cut, so as to lift the cut rib from the supporting block.

16. The equipment according to claim 8,
further comprising a lifter capable of contacting a lower face of the corrugated fin, which has been cut, so as to lift the cut rib from the supporting block.

17. The equipment according to claim 9,
wherein an end face of the lifter, which is located on the supporting block side, slides on the supporting block.

18. The equipment according to claim 10,
wherein an end face of the lifter, which is located on the supporting block side, slides on the supporting block.

19. The equipment according to claim 11,
wherein an end face of the lifter, which is located on the supporting block side, slides on the supporting block.

20. The equipment according to claim 12,
wherein an end face of the lifter, which is located on the supporting block side, slides on the supporting block.
